(19) United States
(12) Patent Application Publication
(10) Pub. No.: US 2024/0292853 A1
(43) Pub. Date: Sep. 5, 2024

(54) BEVERAGE CONTAINING CITRUS FIBER AND PREPARATION METHOD THEREFOR

(71) Applicant: THE COCA-COLA COMPANY, Atlanta, GA (US)

(72) Inventors: Boya LIU, Atlanta, GA (US); Jia LI, Atlanta, GA (US); Fujun GAO, Atlanta, GA (US); Tushar JOSHI, Atlanta, GA (US); Chunbo DENG, Atlanta, GA (US)

(21) Appl. No.: 18/577,834

(22) PCT Filed: Jul. 11, 2022
(86) PCT No.: PCT/US2022/036681

§ 371 Date: Jan. 9, 2024

(30) Foreign Application Priority Data
Jul. 9, 2021 (CN) 202110779247.8

(51) Int. Cl. A23C 9/154; A23C 9/156

(52) U.S. Cl. CPC A23C 9/1544; A23C 9/156

(57) ABSTRACT

Described is a beverage comprising a milk base and 0.3‰ to 5‰ of citrus fiber based on the milk base; wherein a citrus fiber raw material used to prepare the beverage contains 50% to 100% of total dietary fiber and has a particle size D99 of 100 μm-300 μm. Methods for preparing the beverage are also disclosed. Since the indicators of the citrus fiber raw material and the ratio of the citrus fiber raw material to the milk base are strictly controlled in a preparation process, the beverage has a moderate viscosity and a good taste, and it can maintain a long-term stability without adding stabilizers such as gum.

### TECHNICAL FIELD

The present invention relates to a beverage and a method of preparation therefor. Specifically, the present invention relates to a beverage containing citrus fiber and a method of preparation therefor.

### BACKGROUND

Citrus fiber is dietary fiber extracted from the pericarps, peel, and pomaces of fruits such as tangerines, oranges, lemons, etc., including soluble dietary fiber (SDF) and insoluble dietary fiber (IDF). Existing technologies have been used to add citrus fiber to foods such as yogurt, for example:

CN 112889917A discloses a stabilizer for a normal-temperature set-style yogurt, a normal-temperature set-style yogurt and a preparation method therefor. The citrus fiber is used in combination with other ingredients (sodium carboxymethylcellulose, hydroxypropyl distarch phosphate, pectin, agar, carrageenan and diacetyl tartaric acid mono-or di-glyceride) as the stabilizer for a normal-temperature set-style yogurt. However, the normal-temperature set-style yogurt in CN 112889917 A also includes a plurality of artificial stabilizer compositions, wherein the citrus fiber only accounts for 1%-5% of its stabilizing system, which makes little contribution to the stabilizing effect of the whole stabilizing system.

CN 109938097A discloses a clean label yogurt containing citrus fiber and a preparation method therefor. In the method, citrus fiber, preheated raw milk and other ingredients are directly mixed and homogenized to prepare the yogurt. However, in CN 109938097 A, the citrus fiber is not strictly screened, and is easy to cause poor repeatability and unstable quality of the obtained product due to the difference of raw material batches of citrus fiber.

CN 111248285 A discloses an oil-in-water composition and food based on citrus fiber, wherein citrus fiber, fat and water are prepared into the oil-in-water composition based on citrus fiber, and the oil-in-water composition is homogenized several times, in the homogeneous product: the dispersion of the oil-in-water composition based on citrus fiber has a particle size D[4,3] of 0.3-0.7 μm, for example, 0.4-0.5 μm, and a particle size d(0.5) of 0.3-0.7 μm, for example, 0.38-0.42 μm. A fat ingredient is additionally added, and the formed dispersion of an oil-in-water composition based on citrus fiber has a small particle size; in order to achieve such a particle size, multiple homogenizations are required, which consumes excess energy and increases the production cost.

In summary, there is an urgent need for a citrus fiber-containing beverage that can overcome the above defects and its preparation method, especially a citrus fiber-containing beverage and its preparation method, which can simultaneously improve taste, improve anti-sedimentation performance, stabilize quality, extend transportation and storage stability and reduce production costs.

### SUMMARY

The technical problem to be solved by the present invention is to overcome the following shortcomings of the current yogurt containing citrus fiber and a preparation method therefor: the added artificial stabilizer makes the label less clean; the quality of the obtained product is easily unstable due to the difference of raw material batches of citrus fiber; or the citrus fiber is excessively processed, which consumes excess energy and the production cost is too high. The present invention provides a beverage containing citrus fiber with stable quality and low production cost, and a preparation method therefor.

The inventors of the present invention have found for the first time that, when a citrus fiber raw material is strictly controlled, there is no need for excessive processing (e.g., multiple homogenizations, etc.) to particles smaller than 1 micron, and the following technical effects can be obtained: the taste and anti-settling property are improved, the quality is stable, transportation and storage stabilities are prolonged, the suspension effect of beverage particles is enhanced, the appearance and stability are improved, and the production cost is reduced.

The present invention provides a beverage containing citrus fiber. The beverage contains a milk base, and 0.3129 to 5‰ of the citrus fiber based on the milk base; a citrus fiber raw material for preparing the beverage contains 50% to 100% of total dietary fiber and has a particle size D99 of 100 μm-300 μm.

The present invention further provides a method for preparing the above-described citrus fiber-containing beverages, the method comprising:
1) providing a citrus fiber raw material which contains 50% to 100% of total dietary fiber and has a particle size D99 of 100 μm-300 μm;
2) mixing the citrus fiber raw material with water to form a slurry phase, wherein the solid-liquid ratio of the mixture is 1:30 to 1:500,
optionally, mixing the citrus fiber raw material and other solid particle components with water to form a slurry phase, wherein the solid-liquid ratio of the mixture is 1:30 to 1:500;
3) mixing the slurry phase obtained in step 2) with a milk base, wherein the beverage contains 0.3% c to 5% c of the citrus fiber based on the milk base;
4-1) sterilizing a mixture obtained in step 3);
5-1) homogenizing the sterilized mixture in step 4) at a temperature range of 60-75° C., and the average pressure parameter is as follows: a primary pressure is 100-300 bar, a secondary pressure is 25-150 bar, and the pressure difference between the primary pressure and the secondary pressure is 50-200 bar; or
4-2) homogenizing the mixture obtained in step 3) at a temperature range of 60-75° C., and the average pressure parameter is as follows: a primary pressure is 100-300 bar, a secondary pressure is 25-150 bar, and the pressure difference between the primary pressure and the secondary pressure is 50-200 bar;
5-2) sterilizing the mixture obtained in step 4) after homogenization.

Compared with the prior art, the present invention has the following beneficial effect: According to the present invention, the citrus fiber raw material is strictly controlled, in particular, the selected citrus fiber raw material contains 50% to 100% of total dietary fiber and has a particle size D99 of 100 μm-300 μm, there is no need for excessive processing to a particle size smaller than 1 micron and addition of other stabilizers, the following technical effects can be obtained: the taste is improved, the quality is stable, transportation and storage stabilities are prolonged, the suspension effect of beverage particles is enhanced, the appearance and stability are improved, and the production cost is reduced.

From the following detailed description, other objects, features and advantages of the present invention will become apparent. However, it should be understood that the detailed description and specific embodiments, although indicating preferred embodiments of the present invention, are only given in an exemplary manner, because from this detailed description, various changes and improvements in the spirit and scope of the present invention will become apparent to those skilled in the art.

### BRIEF DESCRIPTION OF THE FIGURES

The following drawings form a part of the present description and are included to further illustrate certain aspects of the present invention. The present invention may be better understood by reference to the drawings in combination with the detailed description of specific embodiments presented herein, but the drawings are not intended to limit the protection scope of the present invention.

FIG. 1 shows the particle size distribution of the beverage containing citrus fiber according to example 1 of the present invention;

FIG. 2 shows the particle size distribution of the beverage containing microcrystalline cellulose according to comparative example 1 of the present invention; and

FIG. 3 shows the competitive results of sedimentation rate test of the beverage containing citrus fiber according to Example 1 of the present invention and the beverage containing microcrystalline cellulose and fibrolin of comparative example 1 obtained by using microcrystalline cellulose as a stabilizer.

FIG. 4 shows the competitive results of sedimentation rate test of the beverage containing citrus fiber according to according to Embodiment 2 and Example 3 of the present invention and the beverage containing microcrystalline cellulose as a stabilizer obtained by using microcrystalline crystals and fibrous alcohol.

FIG. 5 shows the settlement rate test results of a beverage containing citrus fibers of the present invention 4-7.

### DETAILED DESCRIPTION

The present invention provides a beverage containing citrus fiber. The beverage contains a milk base, and 0.3‰ to 5‰ of the citrus fiber based on the milk base; a citrus fiber raw material for preparing the beverage contains 50% to 100% of total dietary fiber and has a particle size D99 of 100 μm-300 μm.

The beverage containing citrus fiber provided by the present invention may refer to modulated milk, fermented milk or a beverage containing milk. Optionally, the beverage containing milk comprises a milk-containing beverage, a lactic acid bacteria beverage, milk tea, milk coffee, or a combination thereof. The milk base may be fresh milk and/or reconstituted milk. Based on the beverage containing citrus fiber provided by the present invention, the protein content thereof is 1.0%-8.0%, preferably 1.0%-7.0%, and more preferably 2.5%-6.0%. Preferably, the beverage containing citrus fiber provided by the present invention has a protein content range of ≥2.3 g/100 ml.

Although it is generally believed in the art that the larger the particle size of citrus fiber, the better the suspension force, the inventors of the present invention have found for the first time that, when a citrus fiber raw material for preparing the beverage is strictly controlled, for example, the citrus fiber raw material for preparing the beverage contains 50% to 100% of total dietary fiber and has a particle size D99 of 50 μm-300 μm, there is no need to add other stabilizers, the following technical effects can be obtained: the taste is improved, the quality is stable, the label is clean, transportation and storage stabilities are prolonged, the suspension effect of beverage particles is enhanced, the appearance and stability are improved, and the production cost is reduced. Preferably, the citrus fiber raw material for preparing the beverage contains 80% to 100% of total dietary fiber, more preferably, 90% to 100% of total dietary fiber, and has a particle size D99 of 200 μm-300 μm, more preferably, a particle size D99 of 230 μm-270 μm.

More preferably, the citrus fiber raw material for preparing the beverage is dissolved and dispersed in hot water at 70-90° C. at a concentration of 1%, and cooled to 2-25° C. (most preferably cooled to 25° C.) after high shear at 4,000 rpm for 15-20 min (or in cycle shear at 50-90° C. for 5-50 min), and the obtained dispersion has a viscosity of 50 centipoises to 300 centipoises. The citrus fiber raw material that can reach the viscosity range can obtain better taste in the final product. Most preferably, the citrus fiber raw material for preparing the beverage is dissolved and dispersed in hot water at 70-90° C. at a concentration of 1%, and cooled to 25° C. after high shear at 4,000 rpm for 15-20 min, and the obtained dispersion has a viscosity of 100 centipoises to 250 centipoises. The citrus fiber raw material that can reach the viscosity range can obtain the best taste in the final product.

Further preferably, the citrus fiber raw material for preparing the beverage has a water-retaining property of 10-30 times. Preferably, the citrus fiber raw material having a water-retaining property of 10-20 times can make the finished product more stable in storage and transportation, and the ability to suspend solid particles in the beverage is stronger.

More preferably, the beverage is free of a suspension stabilizing agent. The suspension stabilizing agent refers to substances commonly used in the art to maintain a beverage from being layered, such as colloid, starch, etc., specifically, for example, carrageenan, hydroxypropyl distarch phosphate, sodium carboxymethyl cellulose, pectin, agar, and diacetyl tartaric acid mono-or di-glyceride. The present application replaces an artificially synthesized stabilizer in a food additive with a natural citrus fiber and ensures that various properties of the beverage are not affected, and even improved in some aspects.

More preferably, the beverage of the present invention further contains other solid particle components, which refer to solid particle components insoluble in water and milk base. Preferably, the other solid particle components are selected from the group consisting of chocolate bar, cocoa powder, tea powder and nut powder. Further preferably, the other solid particle components have a particle size D99 range of 80-300 μm in a slurry phase, preferably a particle size D99 range of 100-300 μm. Preferably, the solid particle components reach a particle size D99 range of 80-300 μm before mixed with the citrus fiber raw material. The content of insoluble food particles in the beverage containing citrus fiber provided by the present invention is 0.5-5% by weight. More preferably, the beverage contains not less than 0.75% of cocoa powder.

In addition, the present invention further provides a method for preparing the beverage containing citrus fiber, comprising:
1) providing a citrus fiber raw material which contains 50% to 100% of total dietary fiber and has a particle size D99 of 100 μm-300 μm;
2) mixing the citrus fiber raw material with water to form a slurry phase, wherein the solid-liquid ratio of the mixture is 1:30 to 1:500,
optionally, mixing the citrus fiber raw material and other solid particle components with water to form a slurry phase, wherein the solid-liquid ratio of the mixture is 1:30 to 1:500, preferably 1:80 to 1:200, more preferably 1:100;
3) mixing the slurry phase obtained in step 2) with a milk base, wherein the beverage contains 0.3‰ to 5‰ of the citrus fiber based on the milk base;
4-1) sterilizing a mixture obtained in step 3);
5-1) homogenizing the sterilized mixture in step 4) at a temperature range of 60-75° C., and the average pressure parameter is as follows: a primary pressure range is 100 bar-300 bar, a secondary pressure range is 25 bar-150 bar, and the pressure difference range between the primary pressure and the secondary pressure is 50 bar-200 bar; or
4-2) sterilely homogenizing the mixture obtained in step 3) at a temperature range of 60-75° C., and the average pressure parameter is as follows: a primary pressure range is 100 bar-300 bar, a secondary pressure range is 25 bar-150 bar, and the pressure difference range between the primary pressure and the secondary pressure is 50 bar-200 bar;
5-2) sterilizing the mixture obtained in step 4) after homogenization.

Preferably, the citrus fiber raw material used in step 1) of method of the present invention can be a commercially available citrus fiber product, but the product needs to meet standard of containing 80% to 100% of total dietary fiber and having a particle size D99 of 200 μm-300 μm. More preferably, citrus fiber containing 90% to 100% of total dietary fiber and having a particle size D99 of 230 μm-270 μm. The commercially available citrus fiber product may also be further processed to meet the standard of the present invention. More preferably, the citrus fiber raw material is dissolved and dispersed in hot water at 70-90° C. at a concentration of 1%, and cooled to 25° C. after high shear at 4,000 rpm for 15-20 min, and the obtained dispersion has a viscosity of 50 centipoises to 300 centipoises. Most preferably, the citrus fiber raw material is dissolved and dispersed in hot water at 70-90° C. at a concentration of 1%, and cooled to 25° C. after high shear at 4,000 rpm for 15-20 min, and the obtained dispersion has a viscosity of 100 centipoises to 250 centipoises. Further preferably, the citrus fiber raw material for preparing the beverage has a water-retaining property of 10-20 times.

Preferably, in step 2), a high shear is performed for mixing, and the range of high shear parameters is: 3,000-6,000 rpm for 10-40 min; further preferably, the range of high shear parameters is 4,000-5,000 rpm for 20-30 min; most preferably, the high shear parameter is 4,500 rpm for 25 min. Alternatively, step 2) is performed by cycle shearing at 60-85° C. for 15-35 minutes to complete the mixing.

Preferably, in step 5-1) of the present invention, homogenizing the sterilized mixture in step 4) at a temperature range of 60-75° C., and the average pressure parameter is as follows: a primary pressure range is 200 bar-300 bar, a secondary pressure range is 50 bar-100 bar, and the pressure difference range between the primary pressure and the secondary pressure is 70 bar-150 bar; or in step 4-2), homogenizing the mixture obtained in step 3) at a temperature range of 60-75° C., and the average pressure parameter is as follows: a primary pressure range is 200 bar-300 bar, a secondary pressure range is 50 bar-100 bar, and the pressure difference range between the primary pressure and the secondary pressure is 70 bar-150 bar. Or the primary pressure range is 120 bar-300 bar, the secondary pressure is 30 bar-90 bar, the pressure difference between the primary pressure and the secondary pressure is 70 bar-200 bar. More preferably, the pressure difference between primary and secondary pressures is from 80 bar to 200 bar. The pressure difference of the homogenization will make the entire beverage system more homogenous.

The preferred sterilization method in step 4) of the present invention can be ultra-high temperature instantaneous sterilization (UHT) at a temperature of 110° C. to 145° C. for 4 s to 30 s. Another preferred sterilization method can be direct steam jet heat sterilization or direct steam injection heat sterilization at a temperature of 130° C. to 160° C. for 0.09 s to 15 s, or from 0.05-10 s, preferably form 0.09-8 s.

The other solid particle components refer to solid particle components insoluble in water and the milk base. Preferably, the other solid particle components are selected from the group consisting of chocolate bar, cocoa powder, tea powder and nut powder. Further preferably, the other solid particle components have a particle size D99 of 80-300 μm in a slurry phase, preferably a particle size D99 of 100-300 μm. Preferably, the solid particle components reach a particle size D99 of 80-300 μm before mixed with the citrus fiber raw material. The content of insoluble food particles in the beverage containing citrus fiber provided by the present invention is 0.5-5% by weight. More preferably, the beverage contains not less than 0.75% of cocoa powder.

The object, structural features and advantages of the present invention will be described in further detail below by way of specific examples and in conjunction with the accompanying drawings. The following examples are only exemplified to better illustrate the present invention, and do not limit the scope of protection.

### EXAMPLES

### Example 1

The example illustrates a beverage containing citrus fiber and a preparation method therefor.

TABLE 1
Cocoa milk ingredients containing citrus fiber

| Ingredients | Content (% by weight). | performance |
|---|---|---|
| Citrus fiber | 0.125% | D99 particle size 250 μm |
| raw material | | |
| Cocoa powder | 0.8% | D99 particle size 75 μm |
| Water | 12.5% | Reverse osmosis treatment |
| | | of water |
| Fresh cow milk | 86.575% | Fresh milk having a protein |
| | | content of 3.6%. |

As shown in the table above, a cocoa milk product containing citrus fiber is prepared as follows:
1) a citrus fiber raw material is provided, which contains 85% of total dietary fiber and has a particle size D99 of 250 μm;
2) 12.50 g of the citrus fiber raw material is mixed with 80 g of cocoa powder with a particle size D99 of 75 μm in 1,250 g of water using an instrument (Sliverson LST) at a rotating speed of 4,000 rpm and a temperature of 80° C. to obtain a uniform slurry phase, and the high shear lasts 20 min;
3) the slurry phase obtained in step 2) is mixed with 8657.5 g of fresh cow milk, and same is subjected to UHT sterilization at a temperature of 136° C. for 5 s, and finally, the beverage contains 1.25‰ of the citrus fiber based on the milk base;
4) the mixture obtained in step 3) is homogenized using a sterile homogenizer at 65° C., wherein the homogenizing pressure in the first stage is 250 bar, and the homogenizing pressure in the second stage is 50 bar; and
5) after homogenization, aseptic canning is performed on a laminar flow workbench at 25° C.

### Example 2

The example illustrates a beverage containing citrus fiber and a preparation method therefor.

TABLE 2
Cocoa milk ingredients containing citrus fiber

| Ingredients | Content (% by weight). | performance |
|---|---|---|
| Citrus fiber | 0.2% | D99 particle size 250 μm |
| raw material | | |
| Cocoa powder | 0.8% | D99 particle size 75 μm |
| Water | 12.425% | Reverse osmosis treatment |
| | | of water |
| Fresh milk | 86.575% | Fresh milk has a protein |
| | | content of 3.6%. |

As shown in the table above, a cocoa milk product containing citrus fiber is prepared as follows:
1) a citrus fiber raw material is provided, which contains 85% of the total dietary fiber and has a particle size of D 99 is 250 μm;
2) 20.0 g of the citrus fiber raw material is mixed with 80 g of cocoa powder with a particle size D99 of 75 μm in 1,242.5 g of water using an instrument (Sliverson LST) at a rotating speed of 4,000 rpm and a temperature of 80° C. to obtain a uniform slurry phase, and the high shear lasts 20 min;
3) the slurry phase obtained in step 2) is mixed with 8657.5 g of fresh milk and subjected to UHT sterilization at a temperature of 136° C. for 5 seconds, and finally, the beverage contains 2.0‰ of the citrus fiber based on the milk base;
4) the mixture obtained in step 3) is homogenized using a sterile homogenizer at 65° C., wherein the homogenizing pressure in the first stage is 250 bar, and the homogenizing pressure in the second stage is 50 bar; and.
5) after homogenization, aseptic canning is performed on a laminar flow workbench at 25° C.

### Example 3

The example illustrates a beverage containing citrus fiber and a preparation method therefor.

TABLE 3
Cocoa milk ingredients containing citrus fiber

| Ingredients | Assay (% by weight) | performance |
|---|---|---|
| Citrus fiber | 0.4% | D99 particle size 250 μm |
| raw material | | |
| Cocoa powder | 0.8% | D99 particle size 75 μm |
| Water | 12.225% | Reverse osmosis treatment |
| | | of water |
| Fresh cow milk | 86.575% | Fresh cow milk has a protein |
| | | content of 3.6%. |

As shown in the table above, a cocoa milk product containing citrus fiber is prepared as follows:
1) a citrus fiber raw material is provided, which contains 85% of the total dietary fiber and has a particle size of D 99 is 250 μm;
2) 40.0 g of the citrus fiber raw material is mixed with 80 g of cocoa powder with a particle size D99 of 75 μm in 1,222.5 g of water using an instrument (Sliverson LST) at a rotating speed of 4,000 rpm and a temperature of 80° C. to obtain a uniform slurry phase, and the high shear lasts 20 min
3) the slurry phase obtained in step 2) is mixed with 8,657.5 g of fresh cow milk, and same is subjected to UHT sterilization at a temperature of 136° C. for 5 s, and finally, the beverage contains 4.0‰ of the citrus fiber based on the milk base;
4) the mixture obtained in step 3) is homogenized using a sterile homogenizer at 65° C., wherein the homogenizing pressure in the first stage is 250 bar, and the homogenizing pressure in the second stage is 50 bar; and.
5) after homogenization, aseptic canning is performed on a laminar flow workbench at 25° C.

### Example 4

The example illustrates a beverage containing citrus fiber and a preparation method therefor.

TABLE 4
Cocoa milk ingredients containing citrus fiber

| Ingredients | Assay (% by weight) | performance |
|---|---|---|
| Citrus fiber | 0.3% | D99 particle size 250 μm |
| raw material | | |
| Cocoa powder | 0.8% | D99 particle size 75 μm |
| Water | 12.325% | Reverse osmosis treatment |
| | | of water |
| Fresh milk | 86.575% | Fresh milk has a protein |
| | | content of 3.6%. |

As shown in the table above, a cocoa milk product containing citrus fiber is prepared as follows:
1) a citrus fiber raw material is provided, which contains 85% of the total dietary fiber and has a particle size of D 99 is 250 μm;
2) 21 g of the citrus fiber raw material is mixed with 56 g of cocoa powder with a particle size D99 of 75 μm in 862.75 g of water using an instrument (Sliverson LST) at a rotating speed of 4,000 rpm and a temperature of 80° C. to obtain a uniform slurry phase, and the high shear lasts 20 min
3) the slurry phase obtained in step 2) is mixed with 6060.25 g of fresh milk, and same is subjected to UHT sterilization at a temperature of 136° C. for 5 s, and finally, the beverage contains 3.0‰ of the citrus fiber based on the milk base;
4) the mixture obtained in step 3) is homogenized using a sterile homogenizer at 65° C., wherein the homogenizing pressure in the first stage is 250 bar, and the homogenizing pressure in the second stage is 50 bar; and.
5) after homogenization, aseptic canning is performed on a laminar flow workbench at 25° C.

### Example 5

The example illustrates a beverage containing citrus fiber and a preparation method therefor.

TABLE 5
Cocoa milk ingredients containing citrus fiber

| Ingredients | Assay (% by weight) | performance |
|---|---|---|
| Citrus fiber | 0.08% | D99 particle size 250 μm |
| raw material | | |
| Cocoa powder | 0.8% | D99 particle size 75 μm |
| Water | 12.545% | Reverse osmosis treatment |
| | | of water |
| Fresh milk | 86.575% | Fresh milk has a protein |
| | | content of 3.6%. |

As shown in the table above, a cocoa milk product containing citrus fiber is prepared as follows:
1) a citrus fiber raw material is provided, which contains 85% of the total dietary fiber and has a particle size of D 99 is 250 μm;
2) 5.6 g of the citrus fiber raw material is mixed with 56 g of cocoa powder with a particle size D99 of 75 μm in 878.15 g of water using an instrument (Sliverson LST) at a rotating speed of 4,000 rpm and a temperature of 80° C. to obtain a uniform slurry phase, and the high shear lasts 20 min;
3) the slurry phase obtained in step 2) is mixed with 6060.25 g of fresh milk, and same is subjected to UHT sterilization at a temperature of 136° C. for 5 s, and finally, the beverage contains 0.8‰ of the citrus fiber based on the milk base;
4) the mixture obtained in step 3) is homogenized using a sterile homogenizer at 65° C., wherein the homogenizing pressure in the first stage is 250 bar, and the homogenizing pressure in the second stage is 50 bar; and.
5) after homogenization, aseptic canning is performed on a laminar flow workbench at 25° C.

### Example 6

The example illustrates a beverage containing citrus fiber and a preparation method therefor.

TABLE 6
Cocoa milk ingredients containing citrus fiber

| Ingredients | Assay (% by weight) | performance |
|---|---|---|
| Citrus fiber | 0.4% | D99 particle size 145 μm |
| raw material | | |
| Cocoa powder | 0.8% | D99 particle size 75 μm |
| Water | 12.225% | Reverse osmosis treatment |
| | | of water |
| Fresh milk | 86.575% | Fresh milk has a protein |
| | | content of 3.6%. |

As shown in the table above, a cocoa milk product containing citrus fiber is prepared as follows:
1) a citrus fiber raw material is provided, which contains 85% of the total dietary fiber and has a particle size of D 99 is 145 μm;
2) 28 g of the citrus fiber raw material is mixed with 56 g of cocoa powder with a particle size D99 of 75 μm in 855.75 g of water using an instrument (Sliverson LST) at a rotating speed of 4,000 rpm and a temperature of 80° C. to obtain a uniform slurry phase, and the high shear lasts 20 min;
3) the slurry phase obtained in step 2) is mixed with 6060.25 g of fresh milk, and same is subjected to UHT sterilization at a temperature of 136° C. for 5 s, and finally, the beverage contains 4.0‰ of the citrus fiber based on the milk base
4) the mixture obtained in step 3) is homogenized using a sterile homogenizer at 65° C., wherein the homogenizing pressure in the first stage is 150 bar, and the homogenizing pressure in the second stage is 50 bar; and.
5) after homogenization, aseptic canning is performed on a laminar flow workbench at 25° C.

### Example 7

The example illustrates a beverage containing citrus fiber and a preparation method therefor.

TABLE 7
Cocoa milk ingredients containing citrus fiber

| Ingredients | Assay (% by weight) | performance |
|---|---|---|
| Citrus fiber | 0.2% | D99 particle size 145 μm |
| raw material | | |
| Cocoa powder | 0.8% | D99 particle size 75 μm |
| Water | 12.425% | Reverse osmosis treatment |
| | | of water |
| Fresh milk | 86.575% | Fresh milk has a protein |
| | | content of 3.6%. |

As shown in the table above, a cocoa milk product containing citrus fiber is prepared as follows:
1) a citrus fiber raw material is provided, which contains 85% of the total dietary fiber and has a particle size D99 is 145 μm;
2) 14 g of the citrus fiber raw material is mixed with 56 g of cocoa powder with a particle size D99 of 75 μm in 869.75 g of water using an instrument (Sliverson LST) at a rotating speed of 4,000 rpm and a temperature of 80° C. to obtain a uniform slurry phase, and the high shear lasts 20 min
3) the slurry phase obtained in step 2) is mixed with 6060.25 g of fresh milk, and same is subjected to UHT sterilization at a temperature of 136° C. for 5 s, and finally, the beverage contains 2.0‰ of the citrus fiber based on the milk base
4) the mixture obtained in step 3) is homogenized using a sterile homogenizer at 65° C., wherein the homogenizing pressure in the first stage is 250 bar, and the homogenizing pressure in the second stage is 50 bar; and.
5) after homogenization, aseptic canning is performed on a laminar flow workbench at 25° C.

### Comparative Example 1

A beverage containing microcrystalline cellulose is prepared as described in Example 1, except that 0.2% microcrystalline cellulose and 0.1% mono and diglyceride fatty acid esters as stabilizers is used and no citrus fiber is used as a stabilizer.

### Comparative Example 2

A beverage containing microcrystalline cellulose is prepared as described in Example 2, except that 0.2% microcrystalline cellulose and 0.1% mono and diglyceride fatty acid esters as stabilizers is used and no citrus fiber is used as a stabilizer.

### Effect Verification Example

The beverage containing citrus fiber obtained in Examples 1-7 and the beverage containing microcrystalline cellulose obtained in Comparative Examples 1-2 are tested for particle size distribution and sedimentation rate under the same conditions. The specific test methods and test results are as follows:

1) Particle size distribution test and results

The beverages of Example 1 and Comparative Example 1 are tested for their particle size distribution after standing at a room temperature for 3 months.

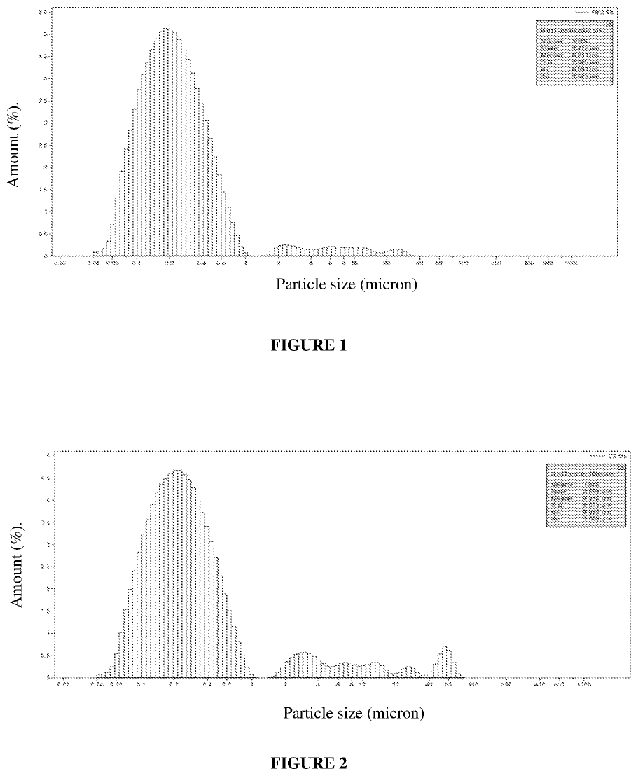

The beverages of Example 1 and Comparative Example 1 are tested by an LSI3 320 laser diffraction particle size analyzer, and the obtained results are shown in FIGS. 1 and 2. FIG. 1 shows the particle size distribution of the beverage containing citrus fiber obtained in Example 1 and FIG. 2 shows the particle size distribution of the beverage containing microcrystalline cellulose obtained in Comparative Example 1.

By analyzing the data, it can be seen that the D(90) value of the sample using citrus fiber is 0.583 μm and the D(90) value of the sample using microcrystalline cellulose is 3.088 μm under the condition that the rest components of the formulation except the stabilizing system are the same. Therefore, it can be known that the particle size of the sample using the citrus fiber in example 1 is generally smaller than that of the sample using microcrystalline cellulose in Comparative Example 1. Therefore, the whole beverage system formed in Example 1 tends to be more stable.

2) Sedimentation rate test and results

The beverages of example 1 and comparative example 1 are tested for their insoluble particle sedimentation states after standing at a room temperature for 3 months.

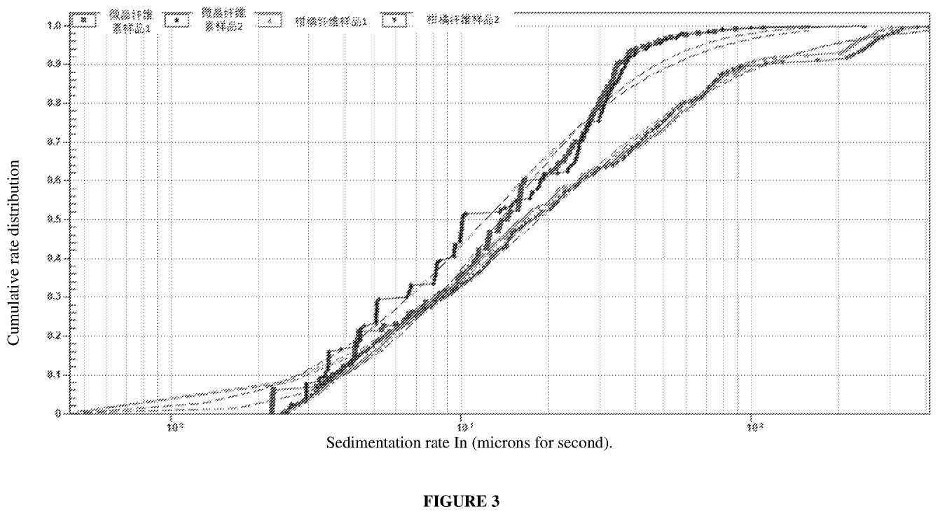

Example 1 and Comparative Example 1 were tested by centrifugal analysis with a LUMiSizer Dispersion Analyser. The results obtained are shown in FIG. 3. FIG. 3 illustrates that in two replicated trials, the sedimentation rate of the beverage containing microcrystalline cellulose of Comparative Example 1 is shown much larger than the beverage containing citrus fiber obtained in Example 1. Thus, it is proved that citrus fiber can slow down the sedimentation rate of insoluble solids in the sample; in the case of small amounts, its performance is still much better than the synthetic stabilizer microcrystalline cellulose, and so that the present invention containing citrus fibers is more stable.

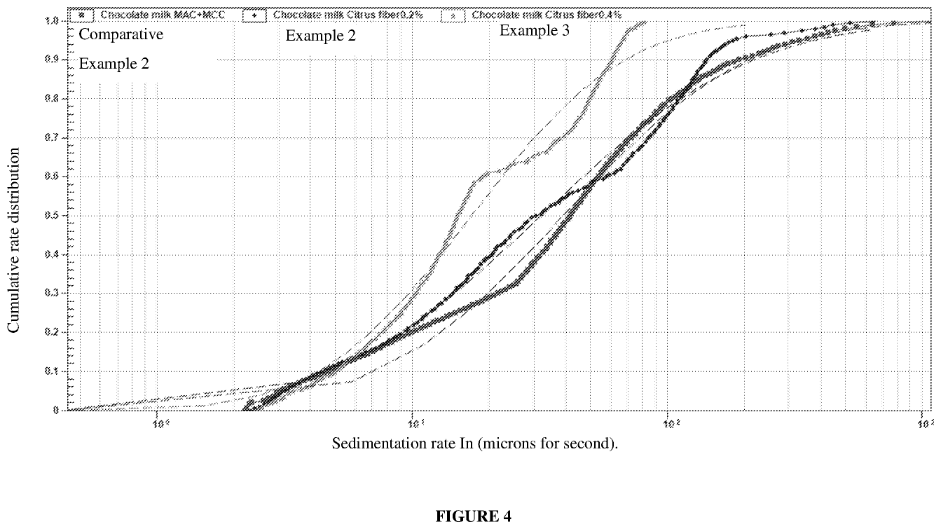

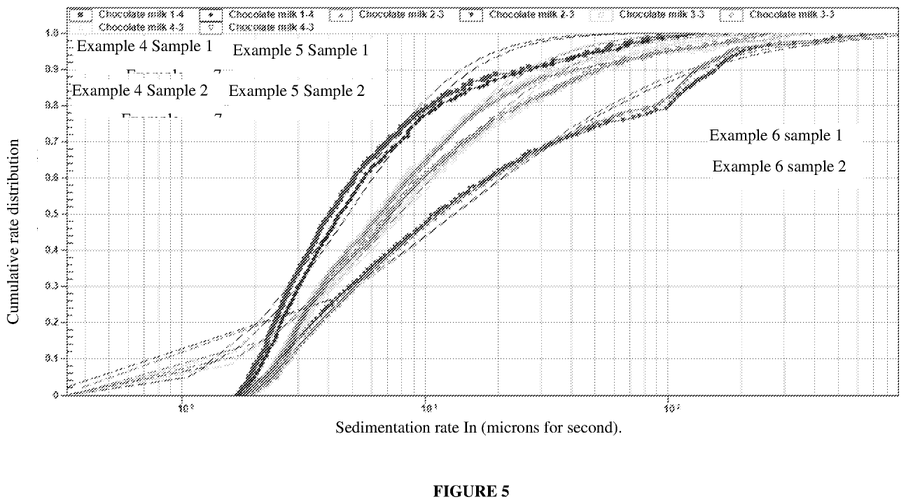

Similarly, the insoluble particle sedimentation state of Examples 2 and 3 and Comparative Example 2 were tested at room temperature after for 3 months. The results obtained are shown in FIG. 4. Compared with beverages containing the same amount of microcrystalline cellulose (Comparative Example 2), the stability of the beverage containing citrus fibers in Example 2 is comparable. The beverage of Example 3 meets the stability requirements.

Examples 4-7 were tested at room temperature for 2 days after their insoluble particle sedimentation state. The results obtained are shown in FIG. 5 wherein each embodiment tests 2 samples. As can be seen from FIG. 5, the beverages of Examples 4-7 are in line with stability requirements, wherein Example 5 has the best stability effect.

The present invention expressively disclosed herein may be appropriately implemented in the absence of any elements not specifically disclosed herein. However, those skilled in the art will apparently be, many changes, changes, improvements, other uses and applications of the method are possible, changes, changes, improvements, other uses and applications that do not deviate from the spirit and scope of the present invention are also considered to be covered by the present invention, the present invention is limited only by the accompanying claims.

1. A beverage comprising a milk base and from 0.3‰ o to 5‰ citrus fiber based on the milk base; wherein a citrus fiber raw materials used to prepare the beverage comprises from 50% to 100% of the total dietary fiber and has a particle size D99 of from 100 μm-300 μm.

2. The beverage according to claim 1, wherein the citrus fiber raw material used to prepare the beverage comprises from 80% to 100% of the total dietary fiber and has a particle size D99 of from 200 μm-300 μm.

3. The beverage according to claim 1, wherein the citrus fiber raw material used to prepare the beverage is dissolved and dispersed in hot water at 70-90° C. at a concentration of 1%, and cooled to 25° C. after high shear at 4000 rpm for 15-20 min, and the resulting dispersion has a viscosity of from 50 centipoise to 300 centipoise.

4. The beverage according to claim 1, wherein the citrus fiber raw material used to prepare the beverage is dissolved and dispersed in hot water at 70-90° C. at a concentration of 1%, and cooled to 25° C. after high shear at 4000 rpm for 15-20 min, and the resulting dispersion has a viscosity of from 100 centipoise to 250 centipoise.

5. The beverages according to claim 1, wherein the citrus fiber raw material used to prepare the beverage has a water retention property of 10-20 times.

6. The beverage according to claim 1, wherein the beverage does not contain a suspension stabilizer.

7. A method for preparing a beverage containing citrus fiber, the method comprising:
1) providing citrus fiber raw material, wherein the citrus fiber raw material comprises from 50% to 100% of the total dietary fiber and has a particle size D99 of from 100 μm to 300 μm;
2) mixing the citrus fiber raw material with water to form a slurry phase, wherein the solid-liquid ratio of the mixture is 1:30 to 1:500;
Optionally, mixing the citrus fiber raw material and other solid particle component with water to form a slurry phase, wherein the solid-to-liquid ratio of the mixture is 1:30 to 1:500;
3) mixing the slurry phase obtained in step 2) with a milk base, wherein the beverage contains 0.3% o to 5% c citrus fiber based on the milk base;
4-1) sterilizing the mixture obtained in step 3);
5-1) homogenizing the mixture after sterilization in step 4) at a temperature of 60-75° C., and the mean pressure parameters are: primary pressure of 100 bar-300 bar, the secondary pressure is 25 bar-150 bar, the pressure difference between the primary pressure and the secondary pressure is 50 bar-200 bar; Or
4-2) homogenizing the mixture obtained in step 3) over a temperature range of 60-75° C., and the mean pressure parameters are: primary pressure of 100 bar-300 bar, the secondary pressure is 25 bar-150 bar, the pressure difference between the primary pressure and the secondary pressure is 50 bar-200 bar;
5-2) sterilizing the homogenized mixture obtained in step 4).

8. The method according to claim 7, wherein in said step 2) a high shear is used to complete the mixing, high shear parameters range is 3000-6000 rpm/min, shear time 10-40 min; Or a cycle shear at 60-85° C. for 15-35 minutes to complete the mixing.

9. The method according to claim 7, wherein steps 5-1) or steps 4-2) the homogeneous pressure difference is 70 bar-150 bar.

10. The method according to claim 7, wherein said other solid particle composition is selected from the group consisting of chocolate chunks, cocoa powder, tea powder and nut powder.

11. The beverage according to claim 2, wherein the citrus fiber raw material used to prepare the beverage is dissolved and dispersed in hot water at 70-90° C. at a concentration of 1%, and cooled to 25° C. after high shear at 4000 rpm for 15-20 min, and the resulting dispersion has a viscosity of from 50 centipoise to 300 centipoise.

12. The beverage according to claim 2, wherein the citrus fiber raw material used to prepare the beverage is dissolved and dispersed in hot water at 70-90° C. at a concentration of 1%, and cooled to 25° C. after high shear at 4000 rpm for 15-20 min, and the resulting dispersion has a viscosity of from 100 centipoise to 250 centipoise.

13. The beverages according to claim 2, wherein the citrus fiber raw material used to prepare the beverage has a water retention property of 10-20 times.

14. The beverage according to claim 2, wherein the beverage does not contain a suspension stabilizer.

15. The method according to claim 8, wherein steps 5-1) or steps 4-2) the homogeneous pressure difference is 70 bar-150 bar.

16. The method according to claim 8, wherein said other solid particle composition is selected from the group consisting of chocolate chunks, cocoa powder, tea powder and nut powder.
